(19) United States
(12) Patent Application Publication
(10) Pub. No.: US 2013/0125699 A1
(43) Pub. Date: May 23, 2013

(54) Method for the Manufacture of a Camshaft

(71) Applicant: NEUMAYER TEKFOR HOLDING GMBH, Hausach (DE)

(72) Inventor: Matthias BECHTOLD, Haslach (DE)

(73) Assignee: NEUMAYER TEKFOR HOLDING GMBH, Hausach (DE)

(21) Appl. No.: 13/744,757

(22) Filed: Jan. 18, 2013

Related U.S. Application Data
(63) Continuation of application No. PCT/DE2011/001207, filed on Jun. 11, 2011.

(30) Foreign Application Priority Data
Jul. 29, 2010 (DE) 10 2010 032 746.8

(51) Int. Cl. B23Q 3/00; F16H 53/02; B23Q 17/00

(52) U.S. Cl. CPC B23Q 3/00; B23Q 17/005; F16H 53/025
USPC 74/567; 29/428; 29/407.08; 269/315

(57) ABSTRACT

A method for manufacturing a shaft, particularly a camshaft, in which the camshaft has a support element and multiple functional elements, each with a recess, and the functional elements are inserted into at least one holder element, and are held immobile in that position, and the support element is inserted into the recesses, also a holder device for manufacturing a camshaft, and a camshaft produced by such a method.

### CROSS REFERENCE TO RELATED APPLICATIONS

This application is a continuation of international patent application no. PCT/DE2011/001207, filed Jun. 11, 2011, designating the United States of America and published in German on Feb. 2, 2012 as WO 2012/013175 A1, the entire disclosure of which is incorporated herein by reference. Priority is claimed based on Federal Republic of Germany patent application no. DE 10 2010032 746.8, filed Jul. 29, 2010, the entire disclosure of which is likewise incorporated herein by reference.

### BACKGROUND OF THE INVENTION

The invention relates to a method for the manufacture of a shaft, particularly a camshaft, wherein the camshaft has a support element and multiple functional elements, each with a recess. In addition, the invention relates to a holder device for the manufacture of a camshaft according to the method according to the invention, as well as to a camshaft manufactured according to the method.

So-called composite camshafts are known in the prior art, wherein the cams are attached on the supporting shaft. This method has the disadvantage that the manufacturing method can take a long time depending on the number of the cams and/or the other functional elements, such as bearings, etc.

### SUMMARY OF THE INVENTION

The invention addresses the problem of providing a manufacturing process which enables a higher production speed for the manufacture of camshafts.

The object of the invention is achieved by providing a method which has at least the following steps: the functional elements are inserted into at least one holder element, and are held there substantially immobile in at least one joining direction, and the support element is inserted, in the joining direction, into the recesses of the functional elements.

As such, by means of the method according to the invention, multiple functional elements—e.g. the individual cams—are attached to the support element—also termed the shaft—at the same time. For this purpose, the functional elements are held in place, such that the correct axial position of the functional elements on the shaft is ensured.

The functional element is either fixed following the attachment thereof on the support element, or a fixing of the same is realized by means of an attachment, e.g. via a press fit.

In general, the joining direction in this case is the direction of the longitudinal axis of the support element, and/or of the camshaft being produced.

The invention is described at this point with reference to a camshaft, but can be used for any other type of shaft.

In one embodiment, the functional elements are inserted into the at least one holder element in such a manner that the recesses of the functional elements are arranged flush behind each other in the axial dimension. In one embodiment, a joining means is inserted during the joining process. In a further embodiment, the device is accommodated in a housing. In one embodiment, a temperature difference is generated between the support element and at least one functional element. In a further embodiment, the functional elements and the support element are substantially at the same temperature.

In one embodiment of the method according to the invention, at least one force is measured, wherein said force is exerted by the support element on the at least one functional element during the insertion of the support element into the recess of the functional element. If the functional elements are attached by means of a press fit, for example, it is advantageous if the force with which the shaft is inserted into the recesses of the functional elements is measured, and particularly documented. In addition, in one embodiment, the force with which the support element is moved during the production process is measured.

In one embodiment of the method according to the invention, at least one functional element is held at a radial orientation from the holder device, wherein said radial orientation can be prespecified. The cams are typically attached with a prespecifiable orientation on the shaft. In order to achieve this, in this embodiment the functional elements are held in place for the assembly in a manner partially based on their radial orientation.

In one embodiment of the method according to the invention, the support element is inserted into the recesses of the functional elements by means of a movement, and to such a depth that the functional elements are in a prespecifiable axial end position on the support element. In this embodiment, the shaft is therefore pushed into all recesses of the functional elements by means of a single movement, and/or by means of a single stroke, to such a depth that the functional elements are then in the “right places.”

In one embodiment of the method according to the invention, the support element is inserted into the recesses of a first fraction of the functional elements, by means of a first movement, to such a depth that the functional elements of the first fraction are in a prespecifiable axial end position on the support element, and the support element is inserted into the recesses of at least one second fraction of the functional elements, by means of a second movement, to such a depth that at least the functional elements of the second fraction are in a prespecifiable axial end position on the support element. In this embodiment, the support element is inserted into the recesses of the functional element by means of at least two movements or strokes. To this end, it is possibly necessary that the distances between the functional elements in the holders optionally are different from the distances on the finished shaft, and/or that, before or during the second movement, a subset of the functional elements is no longer held in place, and is free to move along the axial dimension. In one embodiment of the method according to the invention, the functional elements of the first fraction are released from the axial fixation prior to and/or during the second movement. In this embodiment, a fraction of the functional elements is already at the appropriate axial end position during the production process. So that the support element can be inserted into the other functional elements, the functional elements which have already been placed in the final position are no longer held, and are let free.

The invention also relates to a holder device for the manufacture of a camshaft according to one of the embodiments of the method according to the invention, wherein the configuration includes at least one holder element in which at least one functional element can be inserted, and which holds the at least one functional element fixed substantially in at least one joining direction. In one embodiment, the holder device is preferably designed in such a manner that it is possible to insert at least one functional element into the at least one holder element with a radial orientation, and in such a manner that the at least one holder element holds the at least one functional element substantially fixed in the radial and axial dimensions. In this case, one holder element receives one functional element, or multiple or all functional elements.

In one embodiment of the holder device, the at least one holder element is arranged in a frame. The holder element or the holder elements are therefore arranged, i.e. accordingly attached or fixed, in a frame which can also be designed as a support. They are preferably fixed at that location in such a manner that they can assume different positions, and/or they are optionally arranged flush with each other via matching centering surfaces.

In one embodiment of the holder device, at least one sensor is included which measures at least one force which is exerted on at least one functional element.

In one embodiment of the holder device, at least two holder elements are included, and at least one spacer element is included between the at least two holder elements. As an alternative or complement, the at least two holder elements are connected in a substantially immobilized manner to a support.

Finally, the invention relates to a camshaft produced according to the method according to the invention, and/or produced in the holder device according to the invention. In this case, the support element is a single-piece or multi-piece shaft, for example, which has a variable external diameter in different sections—meaning that it has a stepped construction. By way of example, the step profile can be created by an increasing outer diameter of the support element with a counterposed reduction of the inner diameter of the functional element recesses. As such, upon insertion, the support element with an enlarged periphery passes through recesses which become narrow at each point.

### BRIEF DESCRIPTION OF THE DRAWINGS

The invention will be described in greater detail hereinafter with reference to illustrative embodiments depicted in the accompanying drawing figures, in which:

FIG. 1 shows a holder device according to the invention for the manufacture of a camshaft;

FIG. 2 shows the holder device of FIG. 1 for the manufacture of a camshaft with the support element inserted, and

FIG. 3 shows an alternative embodiment of the holder device according to the invention.

### DETAILED DESCRIPTION OF EMBODIMENTS

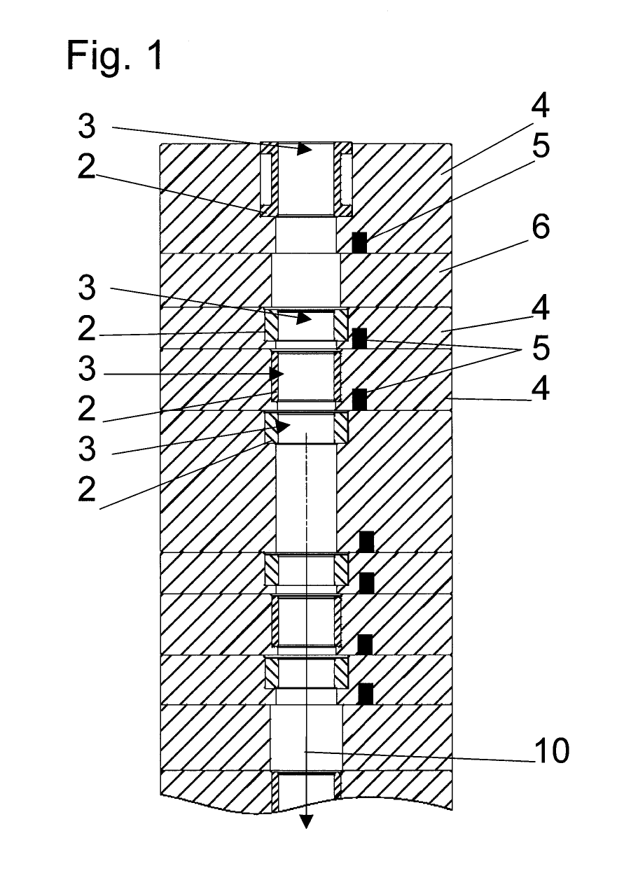

The holder device in FIG. 1 is comprised of multiple holder elements 4 which are arranged directly behind and/or underneath each other in this case. The holder elements or nesters 4 each receive one functional element 2. The functional elements 2 are axial bearings, cams, bearing rings, or roller bearings. The camshaft is adduced at this point as an example for a shaft in production. However, the invention can be used in principle for any type of shaft. The cams in this case are preferably held by the corresponding holder elements 4 with a radial orientation. Some holder elements 4 are arranged directly abutting each other, whereas a spacer 6 is disposed between others.

In an alternative or complementary embodiment, the holder elements 4 are attached on a support element. The holder elements 4 hold the individual functional elements 2 in a joining direction 10, meaning that they prevent a movement of the functional elements 2 in the joining direction 10, essentially counteracting the movement of the support element.

In order to determine the joining force, the force applied by the inserted support element 1 on the individual functional elements 2 is measured by sensors 5. In this case, the latter are, by way of example, force transducers which utilize spring elements, strain gauges, or piezoelectric elements which can be attached on or in a holder element 4, or between two holder elements 4.

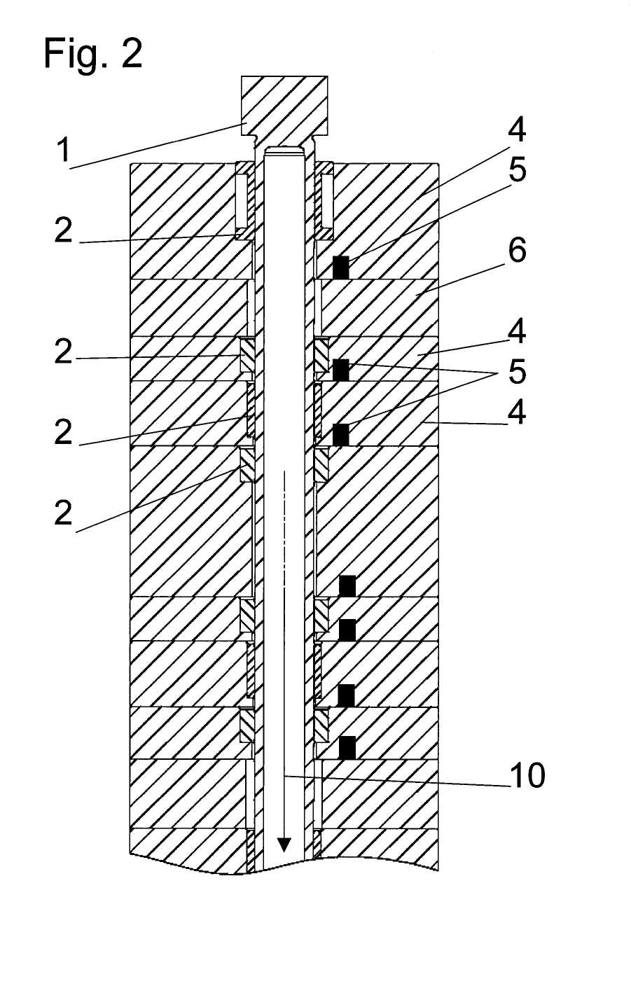

FIG. 2 illustrates the finished camshaft, which results from the insertion of the support element 1 into the recesses 3 of the functional elements 2 in the joining direction 10. The attachment in this case is realized by a press fit, for example.

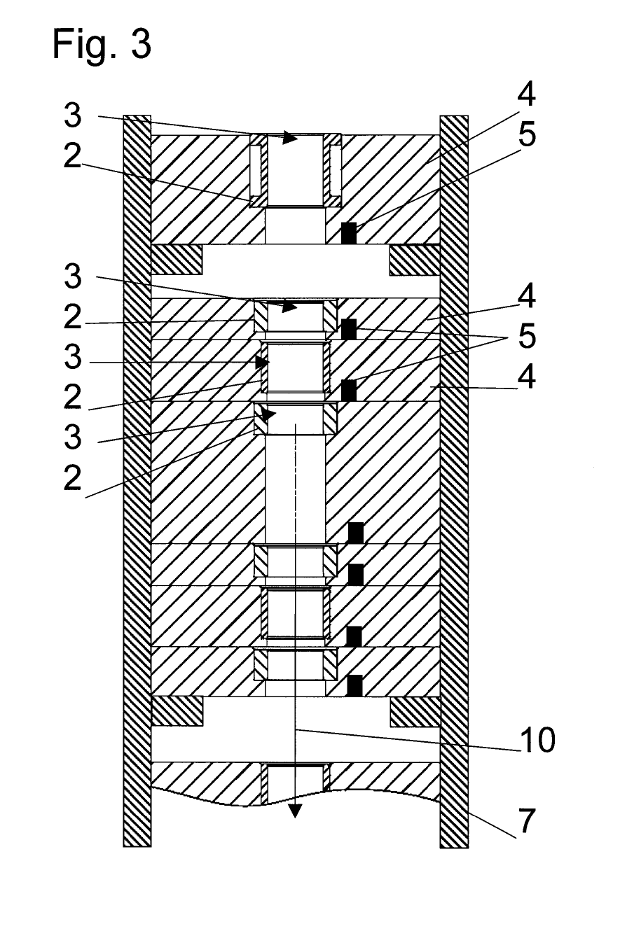

FIG. 3 shows the individual holder elements 4 arranged and fixed in a frame 7.

In principle, the holder device and the method can be used in any type of shaft, wherein functional elements will be applied to the same.

The foregoing description and examples have been set forth merely to illustrate the invention and are not intended to be limiting. Since modifications of the described embodiments incorporating the spirit and substance of the invention may occur to person skilled in the art, the invention should be construed broadly to include all variations within the scope of the appended claims and equivalents thereof.

1. A method for the manufacture of a shaft comprising a support element and a plurality of functional elements each having a recess, said method comprising:
inserting the functional elements into at least one holder element and holding the functional elements substantially fixed at least in a joining direction in the holder element, and
inserting the support element in the joining direction into the recesses of the functional elements.

2. A method according to claim 1, wherein said shaft is a camshaft.

3. A method according to claim 1, wherein at least one force is measured, and the support element exerts said measured force on at least one functional element during the insertion of the support element into the recess of the functional element.

4. A method according to claim 1, wherein at least one functional element is held by the holder device in a prespecified radial orientation.

5. A method according to claim 1, wherein the support element is inserted into the recesses of the functional elements by relative movement between the support element and the functional elements to such a depth that the functional elements are in a prespecified axial end position on the support element.

6. A method according to claim 1, wherein:
the support element is inserted into the recesses of a first fraction of the functional elements by a first relative movement between the support element and the functional elements to such a depth that the functional elements of the first fraction are in a prespecified able axial end position on the support element, and
the support element is inserted into the recesses of at least a second fraction of the functional elements by a second relative movement between the support element and the functional elements to such a depth that the functional elements of the second fraction are in a prespecified axial end position on the support element.

7. A holder device for manufacturing a camshaft by the method of claim 1, wherein
at least one holder element is included,
at least one functional element can be inserted into the said at least one holder element, and
said holder element holds the at least one functional element substantially immobile at least in a joining direction.

8. A holder device according to claim 7, wherein the at least one holder element is arranged in a frame.

9. A holder device according to claim 7, wherein at least one sensor is included which measures at least one force which is exerted on at least one functional element.

10. A holder device according to claim 7, wherein:
at least two holder elements are included, and
at least one spacer element is included between the at least two holder elements.

11. A camshaft produced according to the method of claim 1.
